(19) United States
(12) Patent Application Publication
(10) Pub. No.: US 2003/0148866 A1
(43) Pub. Date: Aug. 7, 2003

(54) Forming roll covers

(76) Inventor: Arved Westerkamp, Poendorf (AT)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/325,256

(22) Filed: Dec. 19, 2002

(30) Foreign Application Priority Data
Dec. 27, 2001 (GB) 0131016.8

(51) Int. Cl. B25F 5/00

(52) U.S. Cl. 492/48

(57) ABSTRACT

A roll cover for covering a perforated roll such as a forming roll in the forming section of a papermaking machine, the roll cover 2 comprising a non-woven, permeable, seamless tube.

### FIELD OF THE INVENTION

The present invention relates to roll covers for covering a perforated roll, and in particular, but not exclusively to shrink sleeves used to cover the forming roll in the forming section of a papermaking machine.

### BACKGROUND OF THE INVENTION

Conventionally, fourdrinier machines were used to form paper sheets, however, as paper machine speeds increased, such machines were found to be inadequate and gap formers were introduced. In the gap former a headbox discharges the stock jet directly between two converging wires known as forming fabrics. Besides giving better drainage than the traditional fourdrinier arrangement, trapping the stock between the forming fabrics significantly reduces stock instability at high machine speeds. There are three main types of gap formers, namely a blade former, a roll former and a roll and blade former. In a blade former drainage occurs by entraining the trapped stock by means of one or more blade shoes. In a roll former the trapped stock is entrained round a forming roll, which may be a suction roll allowing drainage on both sides by a combination of pressure and suction. In a roll and blade former initial drainage occurs over a suction forming roll and then over a blade shoe; this combines steady dewatering from the roll with pulsating pressure from the blades. For the purpose of the present invention only the latter two formers are of importance.

The surface of the forming roll usually carries a plurality of honeycomb shaped perforations in order to allow water to be drawn away rapidly from the web. It is well known that the use of such a roll imparts a hydraulic mark on the paper web unless the roll is additionally covered by a fine woven mesh roll cover which acts as an intermediary to reduce potential marking of the paper by the perforations. However, there are several drawbacks to the woven covers. Firstly, it is well known that the seam joining of such a fabric in order to make it endless, can itself impart a mark to the paper. Secondly when fitted onto a roll, the machine direction yarns of the roll cover lie parallel to the machine direction yarns of the forming fabric. The grid created by the honeycomb perforations of the roll effectively creates the effect of a series of parallel broken lines, and when these lines are parallel to the two sets of parallel machine direction yarns of the shrink sleeve and forming fabric they will be effectively in and out of phase, in that there will be times when all three are perfectly aligned, leading to marking of the paper web, due to total vertical impermeability.

In order to alleviate the above latter described drawback, woven shrink sleeves presently incorporate an offset seam, such that when the sleeve is put onto the roll and shrunk down to fit, the machine direction yarns are effectively at an angle of around 5° to the machine direction yarns of the forming fabric. This is achieved as illustrated in FIG. 9 by removing the portion 30, 32 of the fabric. The ends 34 and 36 are then interengaged and joined to form a seam which lies, when fitted to the roll, at an angle to the axis of the roll. Once shrunk, the edges 38, 40 of the sleeve are glued and then a clamp is put in place to achieve a snug fit. Whilst this method goes some way to reducing the problem of paper marking caused by the alignment of several sets of parallel machine direction lines, it nevertheless has the drawback that because the machine direction yarns of the sleeve are no longer parallel to those of the forming fabric, there is a tendency for the sleeve to attempt to realign itself causing bubbles to form within its structure. This in turn leads to severe marking of the paper and increased wear to the sleeve leading to a reduced life expectancy thereof. Also, the problem concerning marking due to the seam has not been addressed.

An additional problem with woven sleeves is that fibres from the cellulosic slurry block holes and become trapped between the yarn cross-over points in the weave structure which has the effect of pushing the yarn up and thereby inducing marking in the paper web.

It has been known to weave such sleeves endless as a tube, with no seam. However, the alignment of the machine direction yarns of the sleeve with the machine direction lines of the forming fabric and the broken gridlines of of the honeycomb grid, still cause marking.

### OBJECTS OF THE INVENTION

It is an object of the present invention to provide a roll cover which overcomes or alleviates the aforementioned drawbacks.

In accordance with the present invention there is provided a roll cover for a perforated roll, the cover being in the form of a non-woven, permeable, seamless tube. This structure has the advantage that there is no visible seam present along the length of the tube which will impart hydraulic marks to the paper web entrained by the forming fabric around the perforated roll. Also, because the roll cover is non-woven, there are no machine direction yarns to align with those of the forming fabric and thereby lead to non-uniform dewatering.

The roll cover may comprise shrinkable material which may have a shrinkage ≦10% measured on Testrite Apparatus. This allows easy installation of the deliberately oversized cover onto the perforated roll. This cover may then be simply shrunk with heat to effect a tight fit around the supporting roll.

The roll cover may also or alternatively comprise resilient material. This will allow the cover to be stretched prior to delivery onto the roll by means of mechanical and/or thermal assistance. Such a material may have a latent shrinkage of around 5%. This has the advantage that once installed, the cover be supplied with heat to ensure a tight fit around the roll. The roll cover may alternatively be fitted by distorting the ends axially to increase the circumference thereof before it is installed on the roll. Once installed, removal of the force enables the cover to relax and provide a tight fit about the roll.

In a preferred embodiment, the roll over is constructed from a non-woven membrane moulded from thermoplastic polymeric material. This has the advantage that there are no yarn cross over points and so therefore nowhere for the cellulosic fibres to become lodged, thus reducing the incidence of marking. The membrane may be joined to make the tube continuous by way of an invisible seam which is a continuation of the membrane material.

Preferably, the membrane tube has a substantially smooth outer periphery, thus further reducing the incidence of marking.

The polymers used may be selected from a wide range of materials such as polyurethane, polyesters such as polyethylene terephthalate, polyamides such as polyamide 6, 6.6, or 12, and polyolefins.

The membrane may comprise embedded yarns, such yarns may be in the form of high shrink yarn and may comprise a polyester core.

In a further preferred embodiment the roll cover is in the form of a plain, tubular knitted sleeve. Such a sleeve differs from a conventional woven sleeve due to the presence of wales and courses in place of machine direction and cross machine direction yarns. This results in a reduction in the incidence of marking and the cover may be simply shrunk to fit the roll snugly under the influence of heat.

In a further preferred embodiment the roll cover is in the form of a tubular, braided sleeve. In such a structure, there are two systems of parallel yarns which are interlaced and helically wound. Thus there are no machine direction yarns to aline with the intermittent end component of the rolls honeycomb support and the machine direction yarns of the forming fabric. This structure has the additional advantage that it can be distorted by squeezing the ends axially, which increases the circumference in order to allow it to be fitted onto a roll and once in place the sleeve is allowed to contract to ensure a tight fit.

In a further preferred embodiment the roll cover is in the form of a tubular, multi axial, knitted sleeve. In addition to the wale and course yarns of a conventional knit, this contains extra yarns on a bias, giving additional support without contributing to further marking.

The yarns used to construct the knitted or braided sleeves may be resilient. This has the advantage that they can be deformed for installation purposes, removal of the force allowing the sleeve to hug the roll.

The yarns used may also or alternatively include shrinkable yarns. The yarns used can be mono filament with diameters of 0.25 to 1.5 mm. Alternatively the yarns may be multi filament of for example 559 dtex to 20138 dtex nylon or for example 678 dtex to 24390 dtex PET. Possible materials for such mono filament and/or multi filament yarns are polyamide 6, 6.6, 6.10, 6.12, PET, PBT and alloys of these materials.

In a preferred embodiment, at least one peripheral end of the tube forming the roll cover is desirable to the roll. For this purpose the roll cover may comprise a draw string about at least one of its peripheral edges which can be tightened to further secure the roll cover. A draw string is more preferably provided at each end of the tube. This has the advantage that the or each draw string may be used to temporarily secure the roll cover in place on the roll, thereby keeping the cover at the correct location whilst the cover is heat set and/or clamped into place. The or each draw stnng may comprise a single or multiple yarn.

The braided/knitted/membrane roll cover can be produced with a calliper approximately half that of the spiral link sleeve disclosed in EPO 489 557.

### BRIEF DESCRIPTION OF THE DRAWINGS

The invention will be described further hereinunder by way of example only with reference to the accompanying drawings in which:

FIG. 1 is a perspective view of roll cover constructed in accordance with a first embodiment of the present invention;

FIG. 2 is a section view along the line of FIG. 1;

FIG. 3 is a variant on the cover of FIG. 1;

FIG. 4 is a perspective view of a roll cover constructed in accordance with a second embodiment of the present invention;

FIG. 5 is an enlarged view of a detail of the end of the roll cover of FIG. 4;

FIGS. 6 & 7 are similar to FIGS. 4 and 5 but illustrate a third embodiment of roll cover;

FIG. 8 is a schematic view of a forming section of a paper making machine with a roll cover constructed in accordance with the invention in place on a forming roll; and

FIG. 9 illustrates how a forming roll cover is traditionally cut at a specified angle prior to seaming.

### DETAILED DESCRIPTION OF THE INVENTION

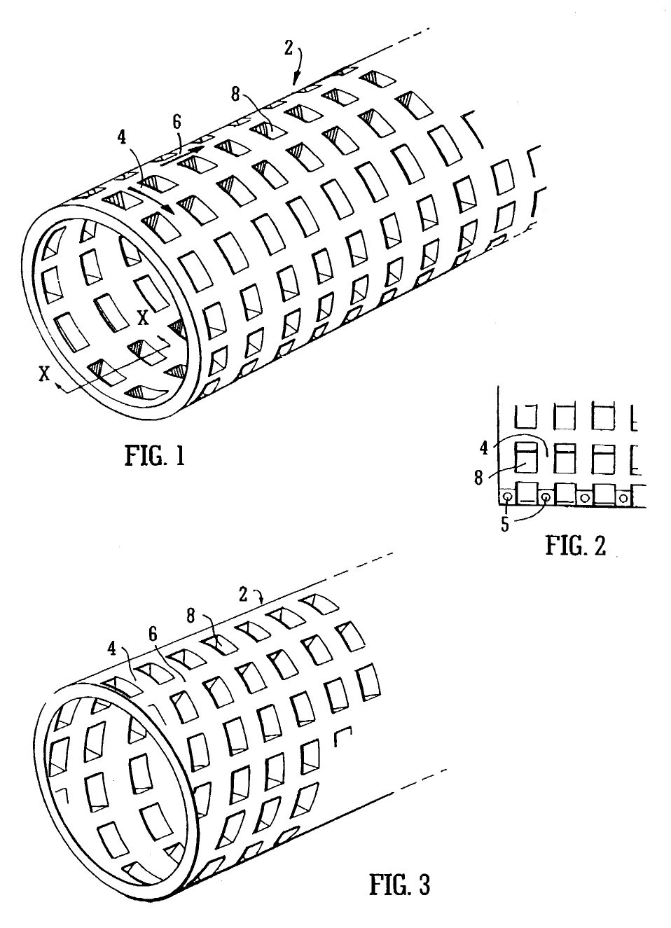

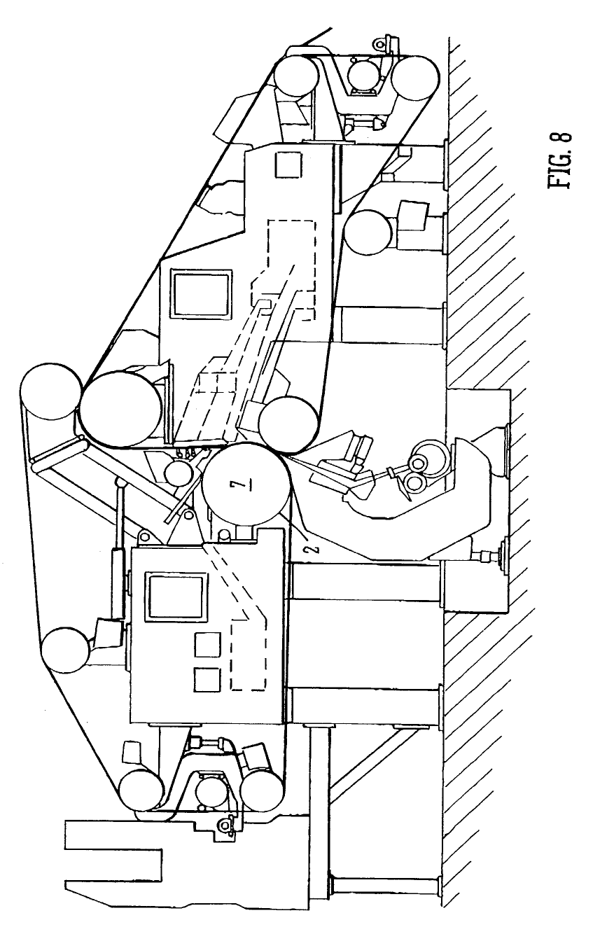

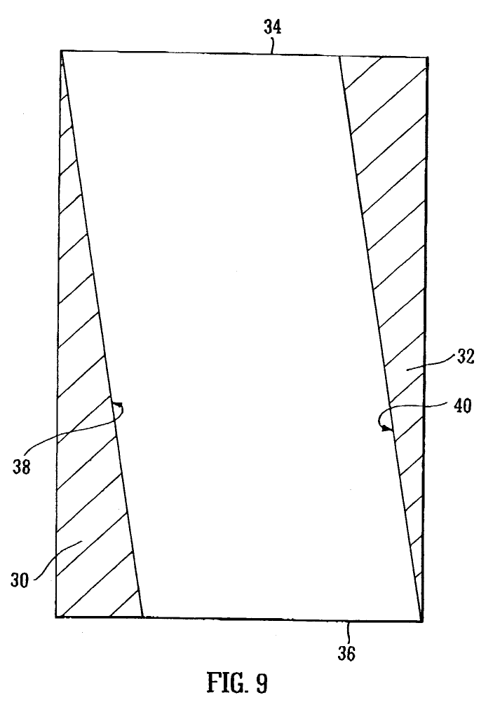

In the embodiment illustrated in FIG. 1 the roll cover comprises a tube 2 of non-woven membrane material, where machine direction 4 and cross machine direction 6 members all reside in the same plane so as to provide a planar surface 4, 6 covering for a roll 7 (see FIG. 8). The tube 2 is joined by way of a non-marking seam which is a continuation of the membrane material.

The membrane is moulded from a non-deformable thermoplastics material, such a polyurethane. By non-deformable it is meant that any deformation that may take place when the roll cover is in use on a roll would be minimal such that fluid passageways 8 provided in the roll cover remain open thereby not hindering the dewatering of the stock.

Referring to FIG. 2 the membrane comprises circumferentially straight yarns 5 embedded within the thermoplastics material. The yarns are in the form of a high shrink yarn with a polyester core.

The diameter of the tube 2 of formed membrane is supplied slightly larger than the diameter of the forming roll to which it is to be applied, such that the membrane sleeve 2 can be easily installed onto the roll. Once in position on the roll the membrane is then heated with an infrared heater or steam in order to shrink it into tight fitting engagement with the surface of the roll. The embedded yarns are shrunk at the same time, providing a structure which is less likely to yield, thereby increasing stability and preventing the membrane from loosening. The membrane 2 thereby forms a shrink sleeve with a non-marking seam within its structure. The planar surface with apertures 8 allow water to be drawn through its structure into the forming roll to increase dewatenng of the paper web entrained about the forming roll between the forming fabrics.

In the embodiment illustrated in FIG. 1 the members 4 and 6 are respectively aligned along the machine direction and cross machine direction, however, the members 4 and 6 may also be aligned at a bias to the machine direction and cross machine direction and therefore the passageways 8 will also extend annularly about the tube 2 in effectively a helical manner.

In the variant of FIG. 3 the membrane is spirally assembled and sideways joined so that the running direction lands do not line up, in use, with the machine direction forming yarns. The join, as above, presenting a non-marking seam which is merely a continuation of the membrane material.

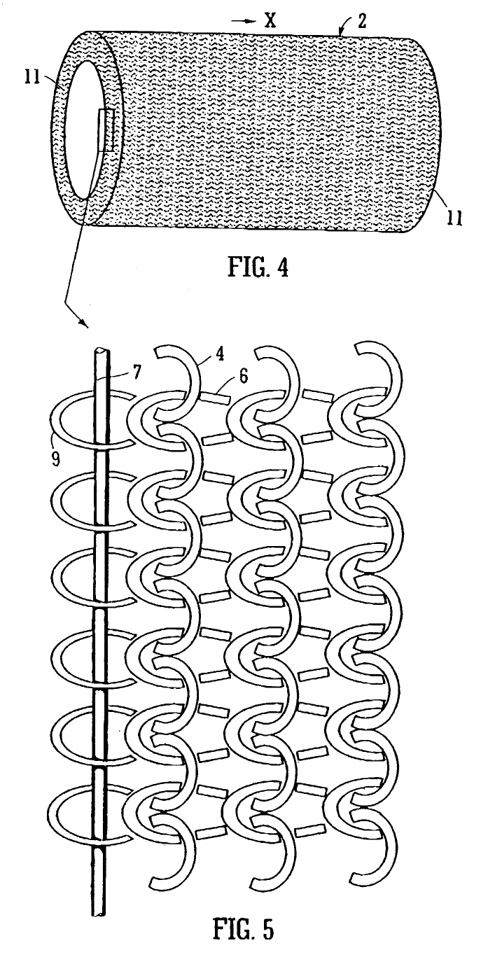

In the embodiment of FIGS. 4 and 5 the roll cover comprises non-woven yarns 4, 6 which have been circularly knitted into a sleeve 2 such that there is ro seam present. The wale and course yarns 4, 6 employed in the knitted sleeve 2 in use, can be stretched to fit over a roll, and then relax to fit tightly against the sleeve.

The yarns used to construct the knitted roll cover may alternatively be high shrink yarns, which can be heat activated using an infrared heater or steam in order to shrink the roll cover onto the roll, once the cover has been installed. The pre-requisite for selection of material to construct the roll cover is a sufficient shrink potential and/or resilience so that the end result is an extremely tight fitting sleeve. For example, a high shrink polyester yarn is used with a hot air shrinkage of approximately 20% at 180° C.

Although the knitted sleeve illustrated in FIGS. 4 and 5 has yarns knitted in the x and y directions only, the sleeve may also comprise yarns at a bias, such yarns may also be shrinkable and/or resilient.

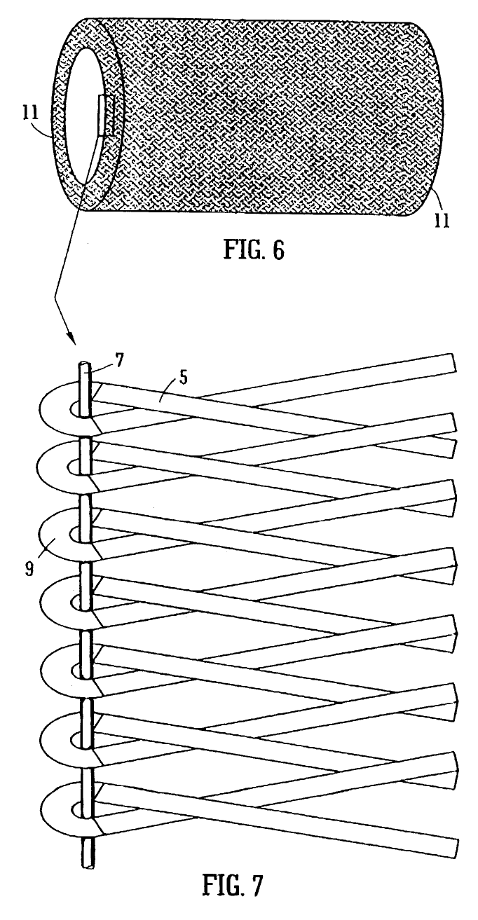

In the embodiment illustrated in FIGS. 6 and 7, the roll cover is formed from braiding together a plurality of yarns 5. The braided yarns may comprise resilient and/or shrinkable yarns as per the knitted sleeve.

In both the knitted and braided forms of the tubes, as best illustrated in FIGS. 5 and 7, the peripheral edge of the tube may also carry a draw string 7 which is threaded through loops 9 provided at the end of the tube 2 and extends about the peripheral edge 11 of the tube. This draw string 7 is tightened once the roll cover is in place on the roll in order to further secure the cover to the roll. Although a draw string has only been illustrated at one end of the roll cover, it is to be understood that a draw string may likewise be provided at the opposite end of the roll cover. The draw string holds the sleeve on the roll until a clamp is used to secure the sleeve in place, often with the addition of an adhesive to further secure the sleeve.

The present roll cover 2 is particularly suited as a shrink sleeve used to cover a forming roll 7 in the forming section of a papermaking machine such as is illustrated in FIG. 8.

The preceding specific embodiments are illustrative ofthe practice of the invention. It is to be understood, however, that other expedients known to those skilled in the art or disclosed herein may be employed without departing from the spirit of the invention or the scope of the appended claims.

We claim:

1. A roll cover for a perforated roll, the cover being in the form of a non-woven, permeable, seamless membrane tube moulded from thermoplastic polymeric material.

2. A roll cover as claimed in claim 1, comprising shrinkable material.

3. A roll cover as claimed in claim 1, comprising shrinkable material with a shrinkage ≦10% measured on Testrite Apparatus.

4. A roll cover as claimed in claim 1, comprising resilient material.

5. A roll cover as claimed in claim 1, comprising resilient material with a latent shrinkage of around 5%.

6. A roll cover as claimed in claim 1, wherein the membrane is joined to make the tube continuous by way of an invisible seam which is a continuation of the membrane material.

7. A roll cover as claimed in claim 1, wherein the membrane tube has a substantially smooth outer periphery.

8. A roll cover as claimed in claim 1, wherein the polymenc material comprises material selected from the group polyurethane, polyesters polyamides and polyolefins.

9. A roll cover as claimed in claim 1, wherein the polymeric material comprises a material selected from the group polyamide 6, 6.6 and 12.

10. A roll cover as claimed in claim 1, wherein the polymeric material comprises polyurethane terephthalate.

11. A roll cover as claimed in claim 1, wherein the membrane comprises embedded yarns.

12. A roll cover as claimed in claim 1 , wherein the membrane comprises high shrink embedded yarns.

13. A roll cover as claimed in claim 1, wherein the membrane comprises embedded yarns with a polyester core.

14. A roll cover for a perforated roll, the roll cover being in the form of a non-woven, permeable, seamless tubular knitted sleeve.

15. A roll cover as claimed in claim 14, wherein the sleeve is a tubular, multi-axial knitted sleeve.

16. A roll cover as claimed in claim 14, comprising resilient yarns.

17. A roll cover as claimed in claim 14, comprising shrinkable yarns.

18. A roll cover as claimed in claim 14, comprising monofilament yarns with diameters of between 0.25 to 1.5 mm.

19. A roll cover as claimed in claim 14, comprising multi-filament yarns.

20. A roll cover as claimed in claim 14, comprising monofilament yarns wherein the matenal of the yarns is selected from the group polyamide 6, 6.6, 6.10, 6.12, PET, PBT and alloys of these materials.

21. A roll cover as claimed in claim 14, comprising nylon, multi-filament yarns with a dtex of between 559 to 20138.

22. A roll cover as claimed in claim 14, comprising PET, multi-filament yarns with a dtex between 678 and 24390.

23. A roll cover as claimed in claim 14 comprising means for securing the cover to a roll.

24. A roll cover as claimed in claim 14, comprising a drawstring provided about one end of said sleeve for securing the roll cover to a roll.

25. A roll cover as claimed in claim 14, comprising two drawstrings each provided about respective opposite ends of the sleeve for securing the roll.

26. A roll cover for a perforated roll, the cover being in the form of a non-woven, permeable, seamless tubular, braided sleeve.

27. A roll cover as claimed in claim 26, comprising resilient yarns.

28. A roll cover as claimed in claim 26, comprising shrinkable yarns.

29. A roll cover as claimed in claim 26, comprising monofilament yarns with diameters of between 0.25 to 1.5 mm.

30. A roll cover as claimed in claim 26, comprising multi filament yarns.

31. A roll cover as claimed in claim 26, comprising monofilament yarns, wherein the material of the yarns is selected fmm the group polyamide 6, 6.6, 6.10,6.12, PET, PBT and alloys of these materials.

32. A roll cover as claimed in claim 26, comprising nylon, multi-filament yarns with a dtex of between 559 to 20138.

33. A roll cover as claimed in claim 26, comprising PET, multi-filament yarns with dtex between 678 and 24390.

34. A roll cover as claimed in claim 26, comprising means for securing the roll cover to a roll.

35. A roll cover as claimed in claim 26, comprising a drawstring provided about one end of said sleeve for securing the roll cover to a roll.

36. A roll cover as claimed in claim 26, comprising two drawstrings each provided about respective opposite ends of the sleeve for securing the roll cover to a roll.
